(19) United States
(12) Patent Application Publication
(10) Pub. No.: US 2020/0383415 A1
(43) Pub. Date: Dec. 10, 2020

(54) SIGNALLING DEVICE FOR TWO-WHEELED VEHICLES

(71) Applicant: COSMO-CONNECTED, Paris (FR)

(72) Inventor: Romain AFFLELOU, London (GB)

(73) Assignee: COSMO-CONNECTED, Paris (FR)

(21) Appl. No.: 16/959,573

(22) PCT Filed: Dec. 21, 2018
(86) PCT No.: PCT/EP2018/086566

§ 371 Date: Jul. 1, 2020

(30) Foreign Application Priority Data
Jan. 5, 2018 (FR) FR1850081

(51) Int. Cl. A42B 3/04; B60Q 1/26

(52) U.S. Cl. CPC A42B 3/0453; B62J 6/165; B60Q 1/2676

(57) ABSTRACT

A signaling device is intended to be worn by a driver or rider of a land vehicle or intended to be mounted on such a vehicle, the vehicle preferably being a two-wheeled vehicle. The signaling device includes an accelerometer, an assembly of electrochemical batteries, a first light source, a wireless communicator intended to emit a warning signal, and a control unit. The control unit is intended to activate: the light source when the accelerometer measures a deceleration greater than or equal to a first predetermined deceleration threshold; and the communicator when the accelerometer measures a deceleration greater than or equal to a second predetermined deceleration threshold.

### CROSS REFERENCE TO RELATED APPLICATIONS

This application is a National Phase Entry of International Patent Application No. PCT/EP2018/086566, filed on Dec. 21, 2018, which claims priority to French Patent Application No. 1850081, filed on Jan. 5, 2018, both of which are incorporated by reference herein.

### TECHNICAL FIELD

The technical field of the present invention is that of signaling devices. More particularly, the present invention relates to a road signaling device intended to be worn by a land vehicle driver or intended to be adapted to a vehicle of this type, this vehicle preferably being a two-wheeled vehicle.

### BACKGROUND

Luminous signaling devices based on the braking of a vehicle are known in the prior art. These devices allow brake lights to light in a variable fashion, depending on the level of braking observed by an accelerometer located in the light source. But to limit the number and the severity of their accidents, it would be appropriate to make the drivers of two-wheeled vehicles more visible, by locating a light source at a higher level above ground than that of the lights of said vehicles, as is the case for the third brake light located on the rear windscreen of three- or four-wheeled vehicles.

Thus on the one hand, drivers of two-wheeled vehicles would be visible through an automobile interleaved between an observer and the brake light with which it would be equipped, and, on the other hand, the distance separating said observer from said driver would be better estimated by said observer. In fact, it has been proven that the human eye better estimates the distance separating it from an object including several lights than that separating an object including only one. In addition, these devices are not designed to emit, in the event of an accident, a signal distinct from that emitted during braking, which can be detrimental to the physical integrity of the driver equipped with said device. There exists a real need to produce an improved signaling device resolving the technical problems mentioned above.

### SUMMARY

To this end, the present invention proposes a signaling device intended to be worn by a land vehicle driver or to be adapted to a vehicle of this type, which vehicle is preferably a two-wheeled vehicle, the device including an accelerometer, an assembly of electrochemical batteries, a first light source, a wireless communication means intended to emit an alarm signal, and a control unit intended to activate

said light source when said accelerometer measures deceleration greater than or equal to a first predefined deceleration threshold, called the braking threshold, and

said communication means when the accelerometer measures a deceleration greater than or equal to a second predefined deceleration threshold, called the accident threshold.

Thanks to these arrangements, on the one hand, a driver equipped with the device according to the invention is more visible during braking and, on the other hand, other drives, rescuers and optionally relations of said driver are instantaneously notified in the event of an accident. According to particular features, this device further comprises a geolocation system intended to measure the geographic coordinates of said device, the alarm signal emitted by the wireless communication means containing said geographic coordinates. Thanks to these arrangements, the drive who is the victim of an accident is precisely localized and can thus be rescued more rapidly.

According to other particular features, this device further comprises a second light source, the control unit further being intended to activate said second light source when said accelerometer measures a deceleration greater than or equal to the second predefined deceleration threshold. Thanks to these arrangements, this second light source, orange in color for example, can blink so as to fulfill a distress light function.

According to other particular features of the device,

the accelerometer is electronic and carries out its measurements along three orthogonal axes,

the control unit is further intended to activate the communication means and/or the second light source when the accelerometer measures a number of swings between acceleration and deceleration greater than or equal to a predefined threshold number of swings, within a predefined period of time. Thanks to these arrangements, the activation of the communication means depends on an additional perimeter, which improves the effectiveness of the device according to the invention.

According to still other particular features, this device further includes a photodiode and a third light source, the control unit further be intended to activate said third light source when said photodiode measures optical radiation less than or equal to a predefined optical radiation threshold. Thanks to these arrangements, this third light source can fulfill a function of position light.

According to other particular features of this device,

the first predefined deceleration threshold is comprised between 0.2 and 0.3 m/s², and

the second predefined threshold is on the order of 20 m/s². The inventors have determined that these arrangements were optimal. Recall that the deceleration values are absolute values.

According to still other particular features, this device further includes

a flexible concave surface intended to be in contact with a helmet on which said device is intended to be fixed, and

a convex surface through which the light source is arranged. Thanks to these arrangements, the device according to the invention assumes the shape of the helmet and has an aerodynamic shape.

According to other particular features of this device, the assembly of electrochemical batteries is rechargeable, via a USB port. Thanks to these arrangements, the use of the device according to the invention is facilitated.

The invention also has as its object an accessory intended to be worn by a driver of a land vehicle, said helmet and said accessory including a signaling device of this type. This accessory can be a helmet or a vest. The advantages linked to this helmet and to this accessory, being similar to those of the device according to the invention, are not recalled here.

### BRIEF DESCRIPTION OF THE DRAWING

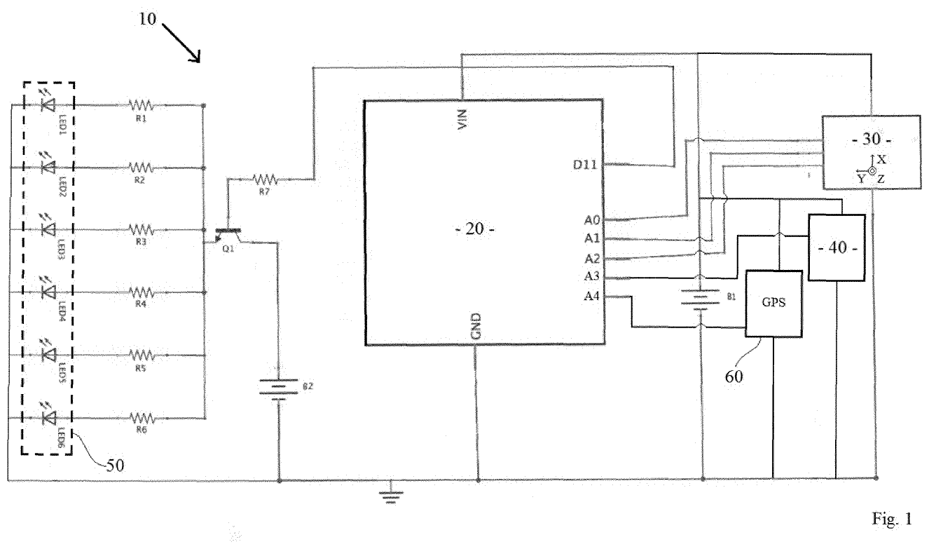

Other features and advantages of the invention will appear upon reading the description which follows of a preferred embodiment of the invention, given by way of an example and with reference to the appended FIG. 1 which shows schematically an example of an electronic circuit of a signaling device according to the invention. Moreover, hereafter in the description, the numerical values mentioned, though not limiting, have been revealed by tests as supplying the most advantageous results.

### DETAILED DESCRIPTION

FIG. 1 shows schematically an exemplary embodiment of an electronic circuit of a signaling device 10 according to the invention. The device 10 is intended to be worn by a driver of a land vehicle, in particular a two-wheeled vehicle intended to circulate on the road, typically a motorcycle or a bicycle. Typically, the device 10 can be attached to or integrated with the back of a helmet, of a vest, of a backpack, or any other accessory intended to be worn by a vehicle driver. Preferably, this circuit is connected to ground, i.e. to the accessory to which it is attached or integrated.

The device 10 includes an accelerometer 30, at least one, here two, electrochemical battery assembly(ies) B1 and B2, a first light source 50 consisting here of six LEDs (LED1-LED6), a wireless communication means 40 intended to emit an alarm signal, and a control unit 20. In a first variant, the light source consists of a plurality of LEDs, eight for example. Typically, this light source 50 has a standard color, i.e. red.

In a second variant, the light source consists of a lighted screen. Preferably, the batteries BI and B2 each have a nominal voltage on the order of 3.7 volts. In the example, the wireless communication means 40 is connected to an input A3 of the control unit 20. In the example, the battery B1 is connected, via a transistor Q1 and six resistors R1, R2, R3, R4, R5 and R6, to the six LEDs (LED1-LED6) of the light source 50 to supply them with electricity. Preferably, the resistors R1, R2, R3, R4, R5 and R6 are on the order of 68 ohms.

In the example an output D11 of the control unit 20 is connected, via a resistor R7, the transistor Q1 and the six resistors R1, R2, R3, R4, R5 and R6, to the six LEDs (LED1-LED6) of the light source 50. Preferably, the resistor R7 is on the order of 150 ohms. In the example, the battery B2 is connected to an input VIN of the control unit 20, to the wireless communication means 40 and the accelerometer 30 to supply them with electricity. The control unit 20 is intended to activate the light source 50 when the accelerometer 30 measures a deceleration greater than or equal to a first predefined deceleration threshold, called the braking threshold. The control unit 20 is also intended to activate the communication means 40 when the accelerometer 30 measures a deceleration greater than or equal to a second predefined deceleration threshold, called the accident threshold.

In one example, the communication means 40 emits the alarm signal via a telecommunications network, GSM for example. Thus rescuers and possibly at least one relation of the driver, are notified as soon as the device 10 undergoes a shock, i.e. as soon as said driver is the victim of an accident. In one variant, the communication means 40 emits the alarm signal via a dedicated application of a mobile telephone of the driver. In this case, the communication means 40 operates for example by Wi-Fi (Wireless Fidelity), Bluetooth or by near field communication (NFC), etc.

Typically, the control unit 20 is of the microprocessor, microcontroller, PLD (programmable logic device), FPGA (field-programmable gate array), EPLD (erasable programmable logic device), CPLD (complex programmable logic device), PAL (programmable array logic), or PLA (programmable logic array) type. Preferably, the device 10 further includes a geolocation system 60, for example of the GPS (Global Positioning System) type, intended to measure the geographic coordinates of said device, the alarm signal containing said geographic coordinates. In the example, the battery B2 is connected to the geolocation system 60, which is itself connected to an input A4 of the control unit 20.

In one example, the device 10 includes a second light source (not shown in FIG. 1). The control unit 20 is then further intended to activate this second light source when the accelerometer 30 measures an acceleration greater than or equal to the second predefined deceleration threshold. In this case, the second light source is preferably orange in color and operates as a blinker.

Preferably, the accelerometer 30 is electronic and carries out its measurements along three orthogonal axes X, Y et Z. In this case, the accelerometer 30 comprises an output to communicate the measurements of each axis X, Y and Z, each of the outputs being connected by a cable connection to a distinct input A0, AI and A2, respectively, of the control unit 20. In this case, the control unit 20 is further intended to activate the communication means 40 and/or the second light source when the accelerometer 30 measures, along at least one of the axes X, Y et Z, a number of swings between acceleration and deceleration greater than or equal to a predefined number of swings threshold, within a predefined time period. In one example, this number of swings threshold is 3 and the predefined time period is 3 seconds.

In one example, the device 10 further includes a photodiode and a third light source (not shown in FIG. 1). The control unit 20 is then further intended to activate this third light source when this photodiode measures optical radiation less than or equal to a predefined optical radiation threshold, i.e. when the external lighting becomes weak. In this case, the third light source would be orange in color and would fulfill the function of a position light.

In another example, the device 10 further includes a fourth light source and a fog and mist detector (not shown in FIG. 1). The control unit 20 is then further intended to activate this fourth light source when this detector measures hygrometry greater than or equal to a predefined hygrometry threshold, i.e. when the humidity of the air becomes high. In this case, this fourth light source could be red in color and would fulfill the function of a fog light. To this end, this fourth light source would be more powerful that the others which are preferably configured to be visible by an observer at 50 meters by day and 150 meters at night.

Preferably, the first predefined deceleration threshold is comprised between 0.2 and 0.3 m/s², and the second predefined deceleration threshold is on the order of 20 m/s².

In the case where the device 10 is attached to a helmet, said device further includes a flexible concave surface (not shown in FIG. 1) intended to be in contact with said helmet, and a convex surface (not shown in FIG. 1) through which the light source(s) 50 are arranged. Preferably, the device 10 is attached removably to the accessory worn by the land vehicle driver. On one example, the flexible element is made of rubber or of any other elastic material, natural and/or synthetic.

Preferably, the assemblies of electrochemical batteries B1 and B2 are rechargeable, via a USB port and, in one example, said batteries are of the lithium-ion polymer type. More preferably, the device 10 includes an indicator of its state of charge (not shown in FIG. 1), which is

either binary if the state of charge is defined as being sufficient or insufficient,

or graduated if said state of charge is defined as being an absolute state of charge.

The present invention can also apply to bicycles, particularly in the case where it is intended to make the cyclist more visible thanks to a brake light system which activates upon the deceleration of the cyclist. This device has a true safety advantage because it makes the cyclist more visible to other users. It can operate autonomously and can also be in communication, preferably by wireless means, with a computer application offering options such as alerting rescuer assistance and an accident detection mode.

In the particular case of bicycles, different options and functionalities, implemented in corresponding computer modules developed by the applicant of the present patent application, are likely to be implemented. In this case, the invention relates to a signaling device 10 intended to be worn by a land vehicle driver or intended to be adapted to a vehicle of this type, this vehicle preferably being a two-wheeled vehicle, which can comprise all or part of the features presented above.

Thus the following functionalities can be implemented:

autonomous activation of the brake lights by the deceleration of the cyclist (as describe above);

the possibility of implementing different lighting modes (position light, brake light, warning mode light);

use and activation of blinkers.

Different triggering modes are possible for activating the blinkers, i.e.:

### Triggering via the Geolocation System, of the GPS Type for Example

The cyclist enters his route in advance into an application allowing the corresponding itinerary to be followed. The blinkers are then triggered depending on the movement of the cyclist on the proposed itinerary, and depending on the geolocation of the cyclist during this movement, in particular upon approaching a detected direction change by the application. In a case of this type, a blinker activation signal is sent to the signaling device, and the corresponding blinker is activated according to the instructions required for the route to be followed.

### Triggering via an Application

The cyclist can activate the blinkers via the application operating on a portable computing device, such as a portable telephone, in a menu of the application specific to this function. The application is launched by the cyclist, the portable computing device being preferably available on the handlebars via for example a support suited to this device. The cyclist then manually triggers the left or right blinker depending on his itinerary.

### Triggering via Remote Control

Such a control can be attached to the handlebars, by attachment or by adhesive means or other attachment means, and allows a cyclist to trigger via a control means, which can be a button such as a pushbutton, the right or left blinker. This remote control is itself in communication with the signaling device, preferably by a wireless means, for example a Bluetooth type communication mode.

Different attachment modes of the signaling device are possible, for example via a clip type system, or any other attachment means such as attachment by adhesive, by means of a ring, etc. This support can be attached to the helmet of the cyclist or to an element of the two-wheeled vehicle, for example on the rear baggage rack of the vehicle, via the attachment system mentioned above.

The device can be connected to a dedicated computer application, as indicated above, the various functionalities implemented on this application being in particular the following:

Geolocation
geolocation of the cyclist by GPS type system;
calculation and proposal of itineraries via the GPS type system linked to different operators and application publishers;
calculation of an itinerary depending on the preferences of the cyclist, for example:
   the cyclist selects an itinerary which uses only hiking paths of the HT (“high-touring”) type or other types;
   the cyclist selects an itinerary depending on defined road parameters (itineraries with or without inclines, itineraries offering bicycle paths, etc . . . );
sharing routes with other users:
   “share” function: access mode on different computing devices such as portable telephones, for sharing routes with other users; this mode offers the possibility of geolocating a relation at any moment; by way of an example, a parent could locate his child during his bicycle during his bicycle routes;
   sharing routes on social networks.

Detection of a fall or of an accident as provided for above, namely among others: the system integrates an algorithm allowing the identification of a fall by the cyclist.

In case of a fall, the application sends an “incident” message to a rescue center which would be capable of verifying (following a telephone call for example) with the cyclist whether an incident has occurred. In case of non-response by the cyclist, rescue can be triggered automatically, in a very short time, preferably less than 5 minutes, by the call center.

The cyclist can also trigger rescue autonomously thanks to an alarm button present in the application.

A relative alarm button is also provided in the application, so that the cyclist can alert his relations, for example by SMS, to an incident.

For children who do not yet have a mobile telephone, an alarm system via remote control allows them to notify their parents in the event of an incident. This additional accessory is similar to, or integrated with, the device for remotely controlling the blinkers to be attached to the handlebars of the bicycle described above.

Data analysis
storage of the history of routes traveled;
analysis of data linked to driving, for example:
   average speed on a route;
   duration of a route;
   distance traveled;
   calories expended;
   analysis of inclines.

Of course, the present invention is not limited to the examples and to the embodiments described and represented, but is subject to numerous variants accessible to a person skilled in the art.

1. A signaling device intended to be worn by a land vehicle driver or intended to be adapted to a vehicle of this type, said device comprising:
(a) an accelerometer;
(b) an assembly of electrochemical batteries;
(c) a first light source;
(d) left and right blinkers;
(e) a wireless communicator configured to emit an alarm signal; and
(f) a control unit intended to activate:
said light source when said accelerometer measures deceleration greater than or equal to a first predefined deceleration threshold, called a braking threshold;
said blinkers being activated according to instructions required for a route to be followed;
said left or right blinkers being triggered by a blinker activation signal upon approaching a detected direction change; and
said communicator when said accelerometer measures a deceleration greater than or equal to a second predefined deceleration threshold, called an accident threshold.

2. The signaling device according to claim 1, further comprising a geolocation system configured to measure geographic coordinates of said device, said alarm signal emitted by said wireless communicator containing said geographic coordinates.

3. The signaling device according to claim 1, wherein said triggering of said blinkers is accomplished via remote control or an application allowing a corresponding itinerary to be followed.

4. The signaling device according to claim 1, wherein said triggering of said blinkers is accomplished via a geolocation system.

5. The signaling device according to claim 1, wherein said blinkers are activated via an application operating on a portable computing device.

6. The signaling device according to claim 1, wherein said blinkers are wirelessly activated in communication with said signaling device, in a Bluetooth type communication mode.

7. The signaling device according to claim 6, further comprising a second light source, said control unit further being configured to activate said second light source when said accelerometer measures a deceleration greater than or equal to said second predefined deceleration threshold.

8. The signaling device according to claim 7, wherein:
said accelerometer is electronic and carries out its measurements along three orthogonal axes;
said control unit is further configured to activate said communicator and/or said second light source when said accelerometer measures a number of swings between acceleration and deceleration greater than or equal to a predefined number of swings threshold, within a predefined time period.

9. The signaling device according to claim 1, further comprising a photodiode and a third light source, said control unit further being configured to activate said third light source when said photodiode measures optical radiation less than or equal to a predefined optical radiation threshold.

10. The signaling device according to claim 1, wherein:
said first predefined deceleration threshold is comprised between 0.2 and 0.3 m/s²; and
said second predefined deceleration threshold is on the order of 20 m/s².

11. The signaling device according to claim 1, further comprising:
a flexible concave surface configured to be in contact with a helmet on which said device is intended to be fixed; and
a convex surface through which said light source is arranged.

12. The signaling device according to claim 1, wherein said assembly of electrochemical batteries is rechargeable, via a USB port.

13. A two-wheeled land vehicle driver-worn accessory including a signaling device comprising:
(a) an accelerometer;
(b) electrochemical batteries;
(c) a first light source;
(d) left and right blinkers;
(e) a wireless communicator operably emitting an alarm signal; and
(f) a control unit operably activating:
said light source when said accelerometer measures deceleration greater than or equal to a braking threshold;
said blinkers being activated according to instructions required for a route to be followed;
said left or right blinkers being triggered by a blinker activation signal upon approaching a detected direction change; and
said communicator, when said accelerometer measures a deceleration greater than or equal to an accident threshold.

14. The accessory according to claim 13, being a helmet, a vest or a backpack.

15. In combination, an accessory and a portion of a two-wheeled land vehicle, said accessory including a signaling device comprising:
(a) an accelerometer;
(b) electrochemical batteries;
(c) a first light source;
(d) left and right blinkers;
(e) a wireless communicator operably emitting an alarm signal; and
(f) a control unit being configured to activate:
said light source when said accelerometer measures deceleration greater than or equal to a braking threshold;
said blinkers being activated according to instructions required for a route to be followed;
said left or right blinkers being triggered by a blinker activation signal upon approaching a detected direction change; and
said communicator, when said accelerometer measures a deceleration greater than or equal to an accident threshold.
